(19) United States
(12) Patent Application Publication
(10) Pub. No.: US 2022/0357924 A1
(43) Pub. Date: Nov. 10, 2022

(54) CIRCUIT MODULE AND METHOD FOR PERFORMING MATRIX MULTIPLICATION

(71) Applicant: Lemon Inc., Grand Cayman (KY)

(72) Inventors: Chuang ZHANG, Los Angeles, CA (US); Shan LU, Los Angeles, CA (US); Junmou ZHANG, Los Angeles, CA (US); Yimin CHEN, Los Angeles, CA (US); Yuanlin CHENG, Beijing (CN); Jian WANG, Beijing (CN)

(21) Appl. No.: 17/737,327

(22) Filed: May 5, 2022

(30) Foreign Application Priority Data
May 7, 2021 (CN) 202110496102.7

(51) Int. Cl. G06F 7/544; G06F 7/523; G06F 7/50; G06N 3/063

(52) U.S. Cl. CPC G06F 7/5443; G06F 7/523; G06F 7/50; G06N 3/063

(57) ABSTRACT

A circuit module for performing matrix multiplication and a method for performing matrix multiplication are provided. The circuit module includes a row-column calculation unit for performing a row-column multiplication calculation. The row-column calculation unit includes a multiplication unit and an addition unit. The multiplication unit is configured to perform a multiplication calculation based on a row matrix element of a first matrix and a column matrix element of a second matrix, and receive at least one electrical signal sequentially inputted in multiple predetermined timing sequences via an input end of the multiplication unit. The electrical signal represents the row matrix element of the first matrix. The addition unit is configured to accumulate a product, obtained by the multiplication unit based on the inputted electrical signal, to perform the row-column multiplication calculation.

### CROSS REFERENCE OF RELATED APPLICATION

The present application claims priority to Chinese Patent Application No. 202110496102.7, titled “CIRCUIT MODULE AND METHOD FOR PERFORMING MATRIX MULTIPLICATION”, filed on May 7, 2021 with the Chinese Patent Office, which is incorporated herein by reference in its entirety.

### FIELD

The present disclosure relates to the technical field of neural networks, and in particular to a circuit module and a method for performing matrix multiplication based on hardware.

### BACKGROUND

With the development of science and technology, a large number of requirements for data processing are generated. The data processing may include implementation of matrix multiplication. The matrix multiplication refers to multiplying two matrices, and may be performed based on a software program. In some application scenarios, matrix multiplication may be performed based on hardware.

### SUMMARY

The content part of the present disclosure is provided to introduce concepts in a brief form, and these concepts are to be described in detail in the following embodiments. The content of the present disclosure is not intended to identify the key features or essential features of the claimed technical solutions, nor is it intended to be used to limit the scope of the claimed technical solutions.

According to the embodiments of the present disclosure, a circuit module for performing matrix multiplication and a method for performing matrix multiplication are provided.

In a first aspect, a circuit module for performing matrix multiplication is provided according to an embodiment of the present disclosure. The circuit module includes a row-column calculation unit for performing a row-column multiplication calculation. The row-column calculation unit includes a multiplication unit and an addition unit. The multiplication unit is configured to perform a multiplication calculation based on a row matrix element of a first matrix and a column matrix element of a second matrix, and receive at least one electrical signal sequentially inputted in multiple predetermined timing sequences via an input end of the multiplication unit. The electrical signal represents the row matrix element of the first matrix. The addition unit is configured to accumulate a product, obtained by the multiplication unit based on the inputted electrical signal, to perform the row-column multiplication calculation.

In a second aspect, a method for performing matrix multiplication is provided according to an embodiment of the present disclosure. The method is applied to the circuit module for performing matrix multiplication according to the first aspect. The method includes: obtaining row matrix elements of a row of a first matrix and column matrix elements of a column corresponding to the row in a second matrix, where the row matrix elements are represented by electrical signals; determining a calculation timing sequence corresponding to each of the row matrix elements; for each of the row matrix elements, inputting the row matrix element to a multiplication unit included in a row-column calculation unit in a calculation timing sequence corresponding to the row matrix element to obtain a product of the row matrix element and a column matrix element corresponding to the row matrix element in the second matrix, and the product is input to the addition unit, and then inputting the product to an addition unit; and accumulating, by the addition unit, products corresponding to the column matrix elements of the row to obtain a result of the row-column multiplication calculation.

In a third aspect, an integrated circuit is provided according to an embodiment of the present disclosure. The integrated circuit includes the circuit module for performing matrix multiplication according to the first aspect.

### BRIEF DESCRIPTION OF THE DRAWINGS

The above and other features, advantages and aspects of the embodiments of the present disclosure will be more apparent in conjunction with the accompanying drawings and with reference to the following embodiments. Throughout the drawings, the same or similar reference numerals represent the same or similar elements. It should be understood that the drawings are schematic and the originals and elements are unnecessarily drawn to scale.

FIG. 1 is a schematic structural diagram of a circuit module for performing matrix multiplication according to some embodiments of the present disclosure;

FIG. 2 is a schematic structural diagram of a circuit module for performing matrix multiplication according to some embodiments of the present disclosure;

FIG. 3 is a schematic structural diagram of a circuit module for performing matrix multiplication according to other embodiments of the present disclosure;

FIG. 4 is a schematic structural diagram of a multiplication unit according to some embodiments of the present disclosure;

FIG. 5 is a schematic structural diagram of a multiplication unit according to other embodiments of the present disclosure;

FIG. 6 is a flow chart of a method for performing matrix multiplication according to some embodiments of the present disclosure;

FIG. 7 is a flow chart of a method for performing matrix multiplication according to other embodiments of the present disclosure; and

FIG. 8 is a flow chart of a method for performing matrix multiplication according to other embodiments of the present disclosure.

### DETAILED DESCRIPTION OF THE EMBODIMENTS

The embodiments of the present disclosure are described in detail below with reference to the accompanying drawings. Although the drawings show some embodiments of the present disclosure, it should be understood that the present disclosure can be implemented in various forms and is not limited to the embodiments. The embodiments are provided for a more thorough and complete understanding of the present disclosure. It should be understood that the drawings and the embodiments in the present disclosure are only illustrative of the disclosure, and are not intended to limit the protection scope of the present disclosure.

It should be understood that the steps of the method according to the embodiments of the present disclosure may be performed in different orders, and/or be performed in parallel. In addition, the method embodiments may include additional steps and/or omit to perform the illustrated steps, not limiting the scope of the present disclosure.

The term “including” and its variants as used herein are open-ended includes, that is, “including but not limited to”. The term “based on” means “based at least in part on.” The term “one embodiment” means “at least one embodiment”. The term “another embodiment” means “at least one additional embodiment”. The term “some embodiments” means “at least some embodiments”. Definitions of other terms are provided in the following description.

It should be noted that, the terms “first”′ “second” and so on mentioned in the present disclosure are only used to distinguishing different apparatuses, modules or units, rather than limit an order of functions performed by the apparatus, module or unit or limit interdependence.

It should be noted that, the terms “one” and “multiple” mentioned in the present disclosure are schematic rather than restrictive, and should be understood as “one or more” by those skilled in the art, otherwise explicitly illustrated in the context.

Names of messages or information interacted between multiple apparatuses in the embodiments of the present disclosure are illustrative rather than limit the scope of the message or information.

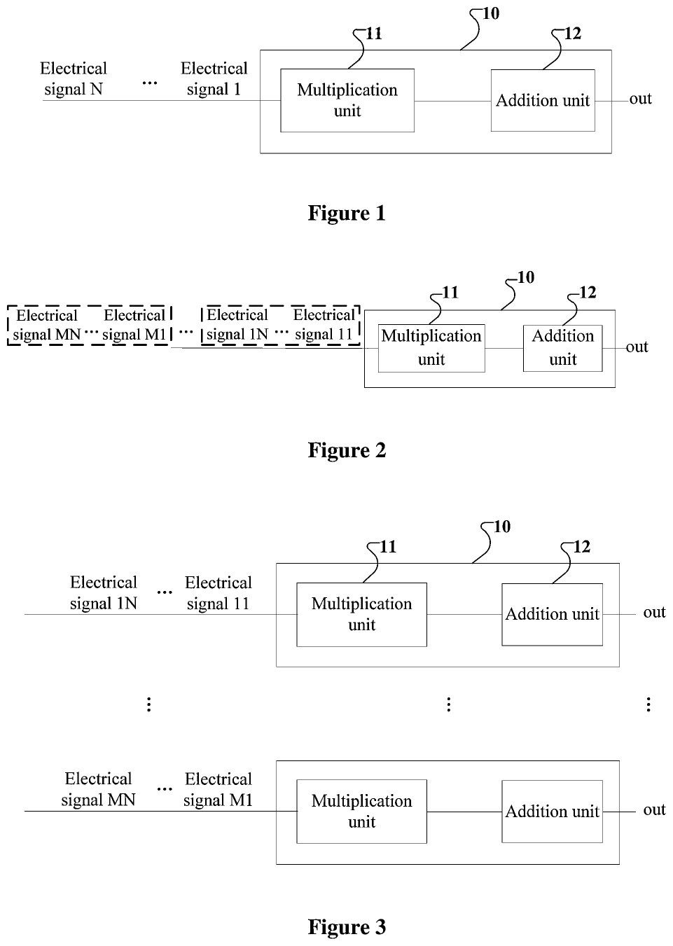

Reference is made to FIG. 1, which shows a schematic structural diagram of a circuit module for performing matrix multiplication according to some embodiments of the present disclosure. As shown in FIG. 1, the circuit module for performing matrix multiplication includes: a row-column calculation unit 10 for performing a row-column multiplication calculation. The row-column calculation unit 10 includes a multiplication unit 11 and an addition unit 12. An output end of the multiplication unit 11 is connected to an input end of the addition unit 12.

The multiplication unit 11 is configured to perform a multiplication calculation based on a row matrix element of a first matrix and a column matrix element of a second matrix.

The addition unit 12 is configured to accumulate a product, obtained by the multiplication unit 11 based on an inputted electrical signal, to perform the row-column multiplication calculation.

The matrix multiplication may be performed based on the first matrix and the second matrix. The matrix multiplication may be performed by performing multiple row-column multiplication calculations. In performing the matrix multiplication, a row-column multiplication calculation may be performed based on a row of the first matrix and each of columns of the second matrix. A multiplication calculation of rows and columns may be performed by performing row-column multiplication calculations on the rows and the columns. For each of the row-column multiplication calculations, the row-column multiplication calculation may be performed by: calculating products of row matrix elements of a row of the first matrix and column matrix element of a column of the second matrix; and accumulating the products to obtain a result of the row-column multiplication calculation.

For each of the row-column multiplication calculations, multiple timing sequences may be predetermined.

The multiplication unit 11 receives, via an input end of the multiplication unit 11, at least one electrical signal sequentially inputted in multiple predetermined timing sequences. The electrical signal represents the row matrix element of the first matrix. The electrical signal may be a voltage signal or a current signal, and the voltage signal is taken as an example for description in the present disclosure. Similarly, the present disclosure may be applied to scenarios where the electrical signal is a current signal.

In a case that the electrical signal is a voltage signal, the voltage signal may be proportional to a row matrix element in the first matrix. Alternatively, a conversion relationship between voltage signals and row matrix elements may be preset, thus the matrix elements may be represented by the voltage signals according to the conversion relationship.

Taking electrical signal 1 to electrical signal N that are shown in FIG. 1 as an example, timing sequences corresponding to the electrical signals 1 to N may be predetermined. In each of the time sequences, an electrical signal corresponding to the time sequence may be inputted to the multiplication unit.

The electrical signals 1 to N may be row matrix elements included in a same row.

For each of the electrical signals, after the electrical signal is inputted to the multiplication unit, the multiplication unit may perform a multiplication calculation on a column matrix element corresponding to the electrical signal.

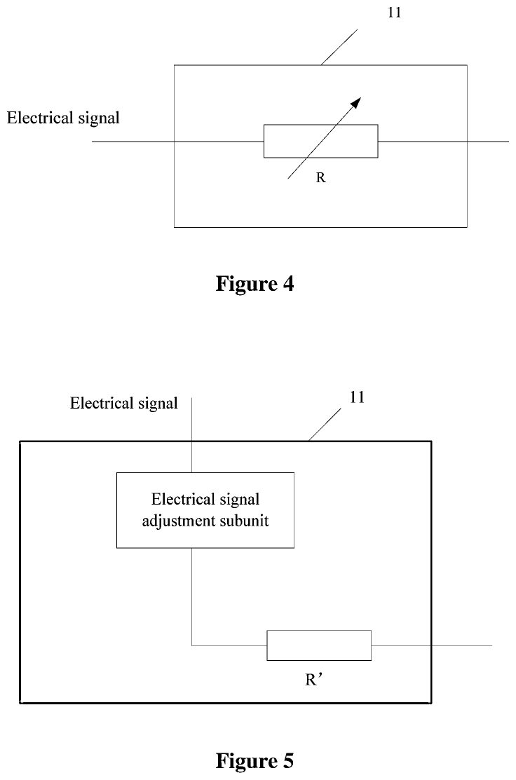

In some embodiments, the multiplication unit includes a first load for implementing the column matrix element. As shown in FIG. 4, the multiplication unit 11 includes a first load R. A load value of the first load may represent the column matrix element.

After applying the electrical signal on the first load, a response signal outputted by the first load may represent a product obtained by performing a multiplication calculation on the row matrix element and the column matrix element.

Further, the first load may include a resistor R, and the load value of the first load may be equal to a conductance of the resistor. The addition unit may include a capacitor.

In practice, after applying an electrical signal representing a row matrix element on a load (that is, the resistor, and the load value of the load represents the column matrix element), a response signal (that is, the product of the voltage signal and the conductance) generated by the load to the electrical signal may represent a product of the row matrix element and the column matrix element.

In some application scenarios, in order to enable the first load to represent column matrix elements having different values, the load value of the first load is adjustable.

In practice, for each of the electrical signals respectively representing row matrix elements of the first matrix, before the electrical signal is inputted to the multiplication unit and in a timing sequence corresponding to the electrical signal, the load value is adjusted based on an adjustment signal for adjusting a load value of a load, so that the load value of the adjusted load may represent a column matrix element corresponding to the electrical signal.

In some application scenarios, for a column matrix element, a timing sequence for inputting a row matrix element corresponding to the column matrix element may be determined by using a timing sequence control circuit. In the time sequence for inputting an electrical signal corresponding to the row matrix element to the multiplication unit, and at the same time or before the row matrix element is inputted to the multiplication unit, a control signal for controlling the adjustment of the load value may be generated by using a logic circuit. With a switching circuit corresponding to the control signal, the control signal is applied to the load having an adjustable load value. The adjusted load value may represent a column matrix element.

In some application scenarios, the load value of the load is adjusted in a timing sequence corresponding to each of the row matrix elements, so that the adjusted load value represents a column matrix elements corresponding to the row matrix element. After applying an electrical signal representing the row matrix element to the load representing the column matrix element, a response signal of the load represents a product of the row matrix element and the column matrix element. Further, the addition unit accumulates the product to perform the row-column multiplication calculation.

In other application scenarios, as shown in FIG. 5, the multiplication unit 11 may include an electrical signal adjustment subunit and a second load R′. The second load R′ has a constant load value. The electrical signal adjustment subunit is configured to adjust the inputted electrical signal. Based on an adjustment ratio of the electrical signal adjustment subunit to the electrical signal and the load value of the load, matching with the matrix elements is realized.

The second load may be a resistor, and the addition unit may include a capacitor.

In some application scenarios, the electrical signal may be a voltage signal, and the electrical signal adjustment subunit includes a voltage signal duty cycle adjustment unit. The electrical signal adjustment subunit may adjust a duty cycle of an inputted voltage signal. A voltage signal applying on the load is adjusted by adjusting a duty cycle of the voltage signal.

The voltage signal duty cycle adjustment unit may include: a switching circuit and a pulse width modulation (PWM) circuit. A voltage signal is inputted to the switching circuit via a signal input terminal of the switching circuit. A signal output terminal of the switching circuit is connected to the second load (a resistor). A control terminal of the switching circuit is connected to an output terminal of the PWM circuit. The PWM circuit outputs a control signal for controlling the electrical signal adjustment subunit. The switching circuit is turned on or turned off under the control of the signal outputted by the PWM circuit. In a case that the switching circuit is turned on, the voltage signal is applied on the second load. In a case that the switching circuit is turned off, the voltage signal is no longer applied on the second load. Based on the control signal, a time length of the voltage signal that is applied on the second load is adjusted, thereby adjusting a duty cycle of the voltage signal applied on the second load. By adjusting the duty cycle of the voltage signal applied on the second load, the voltage signal applied on the second load is adjusted. Therefore, different column matrix elements are realized by controlling the control signal outputted by the PWM circuit.

In some application scenarios, for each of the row matrix elements, the control signal for controlling the electrical signal adjustment subunit may be inputted to the electrical signal adjustment subunit via a control input terminal of the electrical signal adjustment subunit under the control of the switching circuit in a timing sequence corresponding to the row matrix element, where the control signal may be related to a column matrix element corresponding to the row matrix element.

The electrical signal adjustment subunit adjusts the electrical signal inputted to the multiplication unit under the control of the control signal. After applying the adjusted electrical signal on the second load, the second load generates a response signal. The response signal may represent a product of the row matrix element and the column matrix element corresponding to the row matrix element.

In some application scenarios, the load value of the second load is kept unchanged, the electrical signal inputted to the multiplication unit is adjusted, and a column matrix element is represented by an adjustment ratio of the second load to the electrical signal. Therefore, an output signal of the multiplication unit may represent a product of the row matrix element and the column matrix element.

Further, the addition unit accumulates output signals of the multiplication unit in the time sequences to obtain a result of a row-column multiplication calculation of a row of the first matrix and a column corresponding to the row in the second matrix.

With the circuit module for performing matrix multiplication according to the embodiments, a multiplication unit and an addition unit are arranged in a row-column calculation unit; for each of row matrix elements, an electrical signal corresponding to the row matrix element is inputted to the multiplication unit based on a timing sequence corresponding to the row matrix element, then the multiplication unit obtains a product of the row matrix element and a column matrix element corresponding to the row matrix element; and the addition unit accumulates products corresponding to the row matrix elements, thereby performing the row-column multiplication calculation. With the circuit module for performing matrix multiplication according to the embodiments, the number of multiplication units included in the row-column calculation unit is reduced, reducing complexity of and space occupied by a circuit for performing matrix multiplication, thereby facilitating application of the circuit for performing matrix multiplication in a hardware circuit with small size.

Reference is made to FIG. 2, which shows a schematic structural diagram of a circuit module for performing matrix multiplication according to some embodiments of the present disclosure.

As shown in FIG. 2, the circuit module for performing matrix multiplication includes a row-column calculation unit. The row-column calculation unit includes a multiplication unit and an addition unit. The row-column calculation unit sequentially performs row-column multiplication calculations respectively corresponding to rows of the first matrix.

The first matrix is an M*N matrix, that is, the first matrix includes M rows, and each of rows includes N matrix elements. The second matrix may be an N*P matrix, that is, the second matrix includes N rows, and each of rows includes P matrix elements. M, N, and P are respectively positive integers greater than or equal to 1.

In performing one matrix multiplication, M row timing sequences may be set. Elements of M rows in the first matrix are assigned corresponding row timing sequences. For example, elements of a first row are assigned a first row timing sequence, and elements of an M-th row are assigned an M-th row timing sequence.

Further, each of the row timing sequences is divided into multiple column timing sequences. For example, a row timing sequence Ti corresponding to an i-th row may be divided into P column timing sequences, where i is a positive integer greater than or equal to 1 and less than or equal to M.

The row timing sequence Ti may correspond to P row-column multiplication calculations.

In a j-th column timing sequence Tij in the row timing sequence Ti, N row matrix elements in the i-th row may be sequentially inputted to the row-column calculation unit in timing sequences respectively corresponding to the N row matrix elements to perform a row-column multiplication calculation, where j is an integer greater than or equal to 1 and less than or equal to P.

Specifically, the i-th row timing sequence may include N+1 sub timing sequences. In the first N sub timing sequences, the N row matrix elements in the i-th row are sequentially inputted to the multiplication unit. For each of the N row matrix elements in the i-th row, the multiplication unit may obtain a product of the row matrix element and a column matrix element in the j-th column in the second matrix corresponding to the row matrix element. In an (N+1)th sub timing sequence, a result of a row-column multiplication calculation performed on the elements in the i-th row of the first matrix and elements in the j-th column of the second matrix corresponding to the elements in the i-th row of the first matrix is read from the addition unit.

Further, a result of the multiplication calculation performed on the first matrix and the second matrix is determined based on output signals of the addition units in multiple row timing sequences.

The circuit module for performing matrix multiplication shown in FIG. 2 is suitable for application scenarios in which the calculation result of matrix multiplication is not time-sensitive and the product is small in size.

Reference is made to FIG. 3, which shows a schematic structural diagram of a circuit module for performing matrix multiplication according to other embodiments of the present disclosure.

As shown in FIG. 3, the number of the row-column calculation units included in the circuit module for performing matrix multiplication is equal to the number of rows of the first matrix.

Each of the row-column calculation units includes a multiplication unit and an addition unit.

For each of rows in the first matrix, a row-column calculation unit corresponding to the row performs at least one row-column multiplication calculation corresponding to the row.

Taking the first matrix as an M*N matrix and the second matrix as an N*P matrix as an example, M row-column calculation units may be set. Each of the row-column calculation units corresponds to a row of elements in the first matrix and a column of elements in the second matrix.

In performing multiplication calculation on the first matrix and the second matrix, for each of row elements of the first matrix, it is required to respectively perform row-column multiplication calculation on the row element and each of column elements in the second matrix. Column timing sequences respectively corresponding to columns of the second matrix may be set. In each of the column timing sequences corresponding to the columns, row matrix elements in a row of the first matrix are sequentially inputted to a row-column calculation unit corresponding to the row according to timing sequences respectively corresponding to the row matrix elements in the row. Multiplication calculation is performed on the row matrix element and each of column matrix elements in the column of the second matrix. Then, at the end of the column timing sequence, a result of the row-column calculation corresponding to the row of elements and the column of elements is obtained from the addition unit.

Description is provided by taking the first matrix as an M*N matrix and the second matrix as an N*P matrix as an example, where M, N, and P are respectively positive integers greater than or equal to 1.

P column timing sequences may be set in performing matrix multiplication calculation. Each row of elements corresponds to P column timing sequences. In a k-th column time series Rk, for each row of elements, a row-column calculation unit corresponding to the row of elements performs row-column calculation on the row of elements and a k-th column of elements. k is an integer greater than or equal to 1 and less than or equal to P.

For descriptions of the row-column calculation performed on each row of elements and the k-th column of elements, one may refer to the descriptions of the embodiments shown in FIG. 1, which are not repeated herein.

Based on signals out11, . . . , out1p, . . . , outM1, . . . , and outMp, outputted by addition units respectively corresponding to the row-column calculation units, a result of the multiplication calculation performed on the first matrix and the second matrix is determined.

With the circuit module for performing matrix multiplication shown in FIG. 3, the speed of performing matrix multiplication can be accelerated in a case that the space occupied by the circuit module is small.

An integrated circuit is further provided according to an embodiment of the present disclosure. The integrated circuit includes the circuit module for performing matrix multiplication according to the embodiments shown in FIG. 1 to FIG. 3. The integrated circuits may perform various functions.

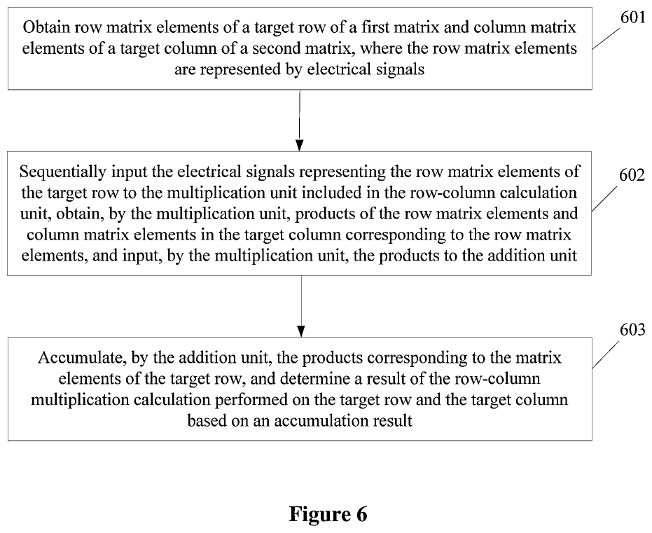

Reference is made to FIG. 6, which shows a flow chart of a method for performing matrix multiplication according to some embodiments of the present disclosure. The method for performing matrix multiplication is applied to the circuit module for performing matrix multiplication shown in FIG. 1.

As shown in FIG. 6, the method for performing matrix multiplication includes performing a row-column multiplication calculation by a row-column calculation unit. The row-column calculation unit includes a multiplication unit and an addition unit. The performing a row-column multiplication calculation includes the following steps 601 to 603.

In step 601, row matrix elements of a target row of a first matrix and column matrix elements of a target column of a second matrix are obtained. The row matrix elements are represented by electrical signals.

In the embodiment, the target row may be any row in the first matrix. The target column may be any column in the second matrix.

In a timing sequence in which row-column calculation is performed on the target row and the target column, the row matrix elements of the target row of the first matrix and the column matrix elements of the target column of the second matrix may be obtained.

The matrix elements in the first matrix may be represented by electrical signals. That is, the electrical signals may represent the matrix elements. The electrical signals may include voltage signals or current signals. In the present disclosure, the electrical signals are taken as voltage signals as an example for description.

In some application scenarios, the first matrix is a feature matrix outputted by a neuron of a neural network. In the application scenarios, each of the matrix elements of the first matrix may represent a feature value outputted by the neuron. The second matrix may be a weight matrix. Weights in the weight matrix correspond to feature values one-to-one.

In step 602, the electrical signals representing the row matrix elements of the target row are sequentially inputted to the multiplication unit included in the row-column calculation unit, products of the row matrix elements and column matrix elements in the target column corresponding to the row matrix elements are obtained by the multiplication unit, and the products are inputted by the multiplication unit to the addition unit.

In step 603, the products corresponding to the matrix elements of the target row are accumulated by the addition unit, and a result of the row-column multiplication calculation performed on the target row and the target column is determined based on an accumulation result.

Specifically, row matrix element timing sequences respectively corresponding to the row matrix elements may be determined. That is, the row matrix elements correspond to the row matrix element timing sequences one-to-one. For each of the row matrix element timing sequences, row matrix elements corresponding to the row matrix element timing sequence are inputted to the multiplication unit in the row matrix element timing sequence, and the multiplication unit obtains products of the row matrix elements and column matrix elements in the target column corresponding to the row matrix elements.

The multiplication unit inputs the products corresponding to the row matrix element timing sequence to the addition unit.

In some application scenarios, the multiplication unit may include a first load. The first load implements the column matrix elements in the target column. The first load may be a variable resistor. The first load has an adjustable load value.

The load value of the resistor may be equal to a conductance (where a conductance is equal to a reciprocal of a resistance). The load value of the resistor is adjustable, that is, the conductance of the resistor is adjustable.

In some application scenarios, the step 602 may include the following operations. First, row matrix element timing sequences respectively corresponding to the row matrix elements are determined. Then, for each of the row matrix element timing sequences, the load value of the first load is adjusted based on column matrix elements corresponding to the row matrix element timing sequence. Then, a first response signal, obtained by applying electrical signals representing row matrix elements corresponding to the row matrix element timing sequence on the first load after adjusting the load value, is determined as the products.

In a row matrix element timing sequence, the conductance of the resistor in the multiplication unit may be adjusted, and the adjusted conductance may represent the column matrix elements of the target column corresponding to the row matrix element timing sequence.

In the row matrix element timing sequence, the electrical signals representing the row matrix elements corresponding to the row matrix element timing sequence are inputted to the multiplication unit. The electrical signals are applied to the resistor after adjusting the conductance. A response signal is generated by the resistor in response to the electrical signals to ensure the products of the row matrix elements and the column matrix elements corresponding to the row matrix elements.

The addition unit includes a capacitor. The first response signal may be a current signal. The step 603 may include: accumulating, by the capacitor, the current signals representing the products corresponding to the matrix elements of each of the rows to obtain accumulated charges, and determining the result of the row-column multiplication calculation based on the accumulated charges.

The result of the row-column multiplication calculation may be determined based on the amount of the charges accumulated on the capacitor. For example, according to a conversion relationship between the electrical signals and the row matrix elements, the accumulated charges is converted into a result of the multiplication calculation.

In some other application scenarios, the multiplication unit includes an electrical signal adjustment subunit and a second load. The electrical signal adjustment subunit is configured to adjust the electrical signals. The second load has a constant load value. The second load may be a resistor.

In these application scenarios, the step 602 may include the following sub-steps. First, row matrix element timing sequences respectively corresponding to the row matrix elements are determined. Then, for each of the row matrix element timing sequences, a control signal for controlling the electrical signal adjustment subunit is determined based on column matrix elements corresponding to the row matrix element timing sequence. Then, the electrical signals are inputted to the multiplication unit. In the multiplication unit, the electrical signal adjustment subunit adjusts the electrical signals based on the control signal and applies the adjusted electrical signals to the second load to obtain a second response signal representing the products.

The electrical signals may be voltage signals. The electrical signal adjustment subunit is configured to adjust duty cycles of the electrical signals. By adjusting the duty ratios of the voltage signals, the voltage signals applied on the second load are adjusted.

The electrical signal adjustment subunit may include a switching circuit, and a control signal generator for generating a control signal for controlling the switching circuit. The control signal is used for controlling the switching circuit to be turned on or turned off. In a case that the switching circuit is turned on, the voltage signal may be directly applied on the second load. In a case that the switching circuit is turned off, the voltage signal is isolated from the second load. The control signal generator may include a pulse width modulation (PWM) circuit. The control signal is generated by the PWM circuit. Specifically, for each of the row matrix element timing sequences, column matrix elements corresponding to the row matrix element timing sequence may be determined, and then a time length of a signal for controlling the switching circuit to be turned on in the control signal is determined based on the column matrix elements. The duty cycle of the electrical signal applied on the second load is controlled based on time length, thereby performing adjustment on the voltage signal applied on the second load.

A second response signal may be obtained after applying the electric signal adjusted by the electric signal adjustment subunit to the second load having a constant load value. The second response signal may represent the products of the row matrix elements and the column matrix elements corresponding to the row matrix element timing sequence.

With the method for performing matrix multiplication according to the embodiments, a multiplication unit and an addition unit are arranged in a row-column calculation unit for performing a row-column multiplication calculation. The row matrix elements are inputted to the multiplication unit sequentially, the multiplication unit obtains products of the row matrix elements and column matrix elements corresponding to the row matrix elements, and then the addition unit accumulates the products, thereby performing the row-column multiplication calculation on the row matrix elements and the column matrix elements. With the method for performing matrix multiplication according to the embodiments, the number of multiplication units included in the row-column calculation unit is reduced, reducing complexity of and space occupied by a circuit for performing matrix multiplication, thereby facilitating application of the circuit for performing matrix multiplication in a hardware circuit with small size.

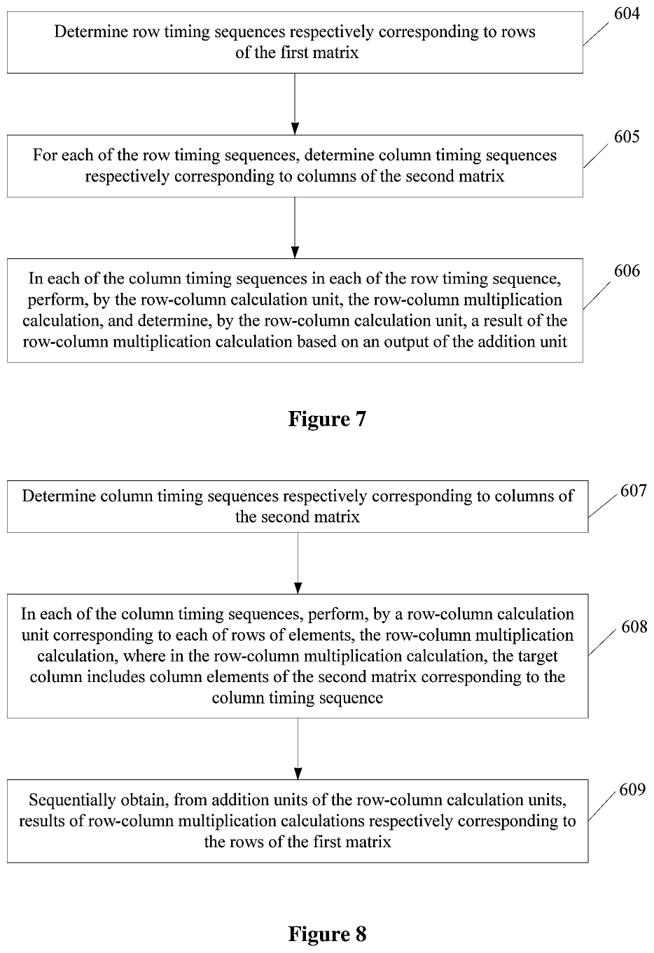

In some optional implementations, the circuit module for performing matrix multiplication includes one row-column calculation unit. The method for performing matrix multiplication includes the following steps 604 to 606 as shown in FIG. 7.

In step 604, row timing sequences respectively corresponding to rows of the first matrix are determined.

In step 605, for each of the row timing sequences, column timing sequences respectively corresponding to columns of the second matrix are determined.

In step 606, in each of the column timing sequences in each of the row timing sequence, the row-column calculation unit performs the row-column multiplication calculation and determines a result of the row-column multiplication calculation based on an output of the addition unit.

In the row-column multiplication calculation, the target row includes the row element of the first matrix corresponding to the row timing sequence, and the target column includes column elements of the second matrix corresponding to the column timing sequence.

Since there is only one row-column calculation unit, multiple row-column multiplication calculations respectively corresponding to rows of elements are performed by the row-column calculation unit. Therefore, it is required to determine a timing sequence for each of the row-column multiplication calculations.

Row timing sequences respectively corresponding to rows of elements of the first matrix may be determined firstly. After the row timing sequences respectively corresponding to the rows are determined, multiple column timing sequences may be determined for each of the row timing sequences. Each of the column timing sequences corresponds to a column of elements of the second matrix.

For a determined row timing sequence and a determined column timing sequence in the row timing sequence, it may be determined that row elements corresponding to the row timing sequence are included in the target row, and a column corresponding to the column timing sequence is the target column.

In the row timing sequence and the column timing sequence in the row timing sequence, a row-column multiplication calculation may be performed on the target row and the target column according to steps 601 to 603.

For each of the column timing sequences, an accumulated result may be read from the addition unit at the end of the column timing sequence, and then a result of the row-column calculation corresponding to the column timing sequence is determined based on the accumulated result.

It should be noted that, the steps 604 and 605 may be performed before the steps 601 to 603.

The method is suitable for application scenarios in which the calculation result of matrix multiplication is not time-sensitive and the product is small in size.

In some optional implementations, the number of the row-column calculation units included in the matrix multiplication unit is equal to the number of rows of the first matrix. The method for performing matrix multiplication includes the following steps 607 to 609 as shown in FIG. 8.

In step 607, column timing sequences respectively corresponding to columns of the second matrix are determined.

In step 608, in each of the column timing sequences, a row-column calculation unit corresponding to each of rows of elements performs the row-column multiplication calculation. In the row-column multiplication calculation, the target column includes column elements of the second matrix corresponding to the column timing sequence.

In step 609, results of row-column multiplication calculations respectively corresponding to the rows of the first matrix are sequentially obtained from addition units of the row-column calculation units.

In these optional implementation embodiments, the number of the row-column calculation units may be equal to the number of the rows of the first matrix. That is, each of the rows corresponds to a row-column calculation unit.

Since each of the rows of the first matrix corresponds to a row-column calculation unit, for each of the rows of the first matrix, multiple row-column multiplication calculations corresponding to the row may be performed by the row-column calculation unit corresponding to the row.

Row timing sequences may be determined based on the number of columns of the second matrix.

In each of column timing sequences, each of the rows of elements may be inputted to a row-column calculation unit corresponding to the row of elements. The multiple row-column calculation units simultaneously perform row-column multiplication calculations respectively on the rows of elements and the column elements corresponding to the column timing sequence.

For each of the rows of elements of the first matrix, a signal representing a result of the row-column multiplication corresponding to the row of elements and a column corresponding to the column timing sequence may be read from an addition unit in each of the row-column calculation unit at the end of the column timing sequence.

For the multiplication calculation performed in each of the row-column calculation unit, one may refer to the descriptions of steps 601 to 603, which are not be repeated herein.

The steps 607 and 608 may be performed before the steps 601 to 603.

In the optional implementation embodiments, the speed of performing the matrix multiplication can be accelerated with a circuit module for performing matrix multiplication occupying small space.

The above description includes merely preferred embodiments of the present disclosure and explanations of technical principles used. Those skilled in the art should understand that the scope of the present disclosure is not limited to technical solutions formed by a specific combination of the above technical features, but covers other technical solutions formed by any combination of the above technical features or equivalent features thereof without departing from the concept of the present disclosure. For example, a technical solution formed by interchanging the above features with technical features having similar functions as disclosed (but not limited thereto) is also covered in the scope of the present disclosure.

In addition, although the operations are described in a specific order, it should not be understood that these operations are to be performed in the specific order shown or performed in a sequential order. Under certain circumstances, multitasking and parallel processing may be advantageous. Although the specific implementation details are described above, these implementation details should not be construed as limiting the scope of the present disclosure. The features described in multiple separate embodiments may be implemented in combination in a separate embodiment. Conversely, the features described in a separate embodiment may be implemented in multiple embodiments individually or in any suitable sub-combination.

Although the solutions according to the present disclosure have been described in language specific to structural features and/or logical actions of the method, it should be understood that the solutions defined in the appended claims are unnecessarily limited to the specific features or actions described above. The specific features and actions described above are merely exemplary forms of implementing the claims.

1. A circuit module for performing matrix multiplication, comprising a row-column calculation unit for performing a row-column multiplication calculation, wherein
the row-column calculation unit comprises a multiplication unit and an addition unit, and an output end of the multiplication unit is connected to an input end of the addition unit;
the multiplication unit is configured to perform a multiplication calculation based on a row matrix element of a first matrix and a column matrix element of a second matrix, and receive at least one electrical signal sequentially inputted in a plurality of predetermined timing sequences via an input end of the multiplication unit, wherein the electrical signal represents the row matrix element of the first matrix; and
the addition unit is configured to accumulate a product, obtained by the multiplication unit based on the inputted electrical signal, to perform the row-column multiplication calculation.

2. The circuit module according to claim 1, wherein
the circuit module comprises one row-column calculation unit, and the row-column calculation unit is configured to perform a row-column multiplication calculation corresponding to a row of the first matrix.

3. The circuit module according to claim 1, wherein
the number of the row-column calculation unit comprised in the circuit module is equal to the number of a row of the first matrix, and a row-column calculation unit corresponding to the row of the first matrix performs a row-column multiplication calculation corresponding to the row.

4. The circuit module according to claim 1, wherein the multiplication unit comprises a first load for implementing the column matrix element.

5. The circuit module according to claim 4, wherein the first load comprises a resistor and the addition unit comprises a capacitor.

6. The circuit module according to claim 4, wherein the first load is configured to have an adjustable load value.

7. The circuit module according to claim 4, wherein the multiplication unit comprises an electrical signal adjustment subunit and a second load, the electrical signal adjustment subunit is configured to adjust the electrical signal, and the second load is configured to have a constant load value.

8. The circuit module according to claim 7, wherein the electrical signal comprises a voltage signal, and the electrical signal adjustment subunit comprises a voltage signal duty cycle adjustment unit.

9. The circuit module according to claim 1, wherein the circuit module is configured to perform a convolution calculation based on a feature matrix outputted by a neuron of a neural network and a weight matrix.

10. A method for performing matrix multiplication, applied to the circuit module for performing matrix multiplication according to claim 1, wherein the method comprises performing a row-column multiplication calculation by a row-column calculation unit, and the row-column calculation unit comprises a multiplication unit and an addition unit, wherein the performing a row-column multiplication calculation comprises:
obtaining row matrix elements of a target row of a first matrix and column matrix elements of a target column of a second matrix, wherein the row matrix elements are represented by electrical signals;
sequentially inputting the electrical signals representing the row matrix elements of the target row to the multiplication unit comprised in the row-column calculation unit, obtaining, by the multiplication unit, products of the row matrix elements and column matrix elements in the target column corresponding to the row matrix elements, and inputting, by the multiplication unit, the products to the addition unit; and
accumulating, by the addition unit, the products corresponding to the matrix elements of the target row, and determining a result of the row-column multiplication calculation performed on the target row and the target column based on an accumulation result.

11. The method according to claim 10, wherein the circuit module for performing matrix multiplication comprises one row-column calculation unit, and the method further comprises:
determining row timing sequences respectively corresponding to rows of the first matrix;
for each of the row timing sequences, determining column timing sequences respectively corresponding to columns of the second matrix; and
in each of the column timing sequences in each of the row timing sequence, performing, by the row-column calculation unit, the row-column multiplication calculation, and determining, by the row-column calculation unit, a result of the row-column multiplication calculation based on an output of the addition unit; wherein
in the row-column multiplication calculation, the target row corresponds to a row timing sequence, and the target column corresponds to a column timing sequence in the row timing sequence.

12. The method according to claim 10, wherein the number of the row-column calculation unit comprised in the circuit module for performing matrix multiplication is equal to the number of rows of the first matrix, and the method further comprises:
determining column timing sequences respectively corresponding to columns of the second matrix;
in each of the column timing sequences, performing, by a row-column calculation unit corresponding to each of rows of elements, the row-column multiplication calculation, wherein in the row-column multiplication calculation, the target column comprises column elements of the second matrix corresponding to the column timing sequence; and
sequentially obtaining, from addition units of the row-column calculation units, results of row-column multiplication calculations respectively corresponding to the rows of the first matrix.

13. The method according to claim 11, wherein
the multiplication unit comprises a first load for implementing the column matrix elements, and the first load has an adjustable load value; and
the sequentially inputting the electrical signals respectively representing the row matrix elements of the target row to the multiplication unit comprised in the row-column calculation unit, obtaining, by the multiplication unit, products of the row matrix elements and column matrix elements in the target column corresponding to the row matrix elements, and inputting, by the multiplication unit, the products to the addition unit comprises:
determining row matrix element timing sequences respectively corresponding to the row matrix elements;
for each of the row matrix element timing sequences, adjusting the load value of the first load based on column matrix elements corresponding to the row matrix element timing sequence; and
determining a first response signal, obtained by applying electrical signals representing row matrix elements corresponding to the row matrix element timing sequence on the first load after adjusting the load value, as the products.

14. The method according to claim 12, wherein
the multiplication unit comprises a first load for implementing the column matrix elements, and the first load has an adjustable load value; and
the sequentially inputting the electrical signals respectively representing the row matrix elements of the target row to the multiplication unit comprised in the row-column calculation unit, obtaining, by the multiplication unit, products of the row matrix elements and column matrix elements in the target column corresponding to the row matrix elements, and inputting, by the multiplication unit, the products to the addition unit comprises:
determining row matrix element timing sequences respectively corresponding to the row matrix elements;
for each of the row matrix element timing sequences, adjusting the load value of the first load based on column matrix elements corresponding to the row matrix element timing sequence; and
determining a first response signal, obtained by applying electrical signals representing row matrix elements corresponding to the row matrix element timing sequence on the first load after adjusting the load value, as the products.

15. The method according to claim 13, wherein
the first load comprises a variable resistor, the addition unit comprises a capacitor, and the first response signal is a current signal; and
the accumulating, by the addition unit, the products corresponding to the matrix elements of the target row, and determining, based on an accumulation result, a result of the row-column multiplication calculation performed on the target row and the target column comprises:
accumulating, by the capacitor, the current signals representing the products corresponding to the matrix elements of each of the rows to obtain accumulated charges, and determining the result of the row-column multiplication calculation based on the accumulated charges.

16. The method according to claim 14, wherein
the first load comprises a variable resistor, the addition unit comprises a capacitor, and the first response signal is a current signal; and
the accumulating, by the addition unit, the products corresponding to the matrix elements of the target row, and determining, based on an accumulation result, a result of the row-column multiplication calculation performed on the target row and the target column comprises:
accumulating, by the capacitor, the current signals representing the products corresponding to the matrix elements of each of the rows to obtain accumulated charges, and determining the result of the row-column multiplication calculation based on the accumulated charges.

17. The method according to claim 11, wherein
the multiplication unit comprises an electrical signal adjustment subunit and a second load, the electrical signal adjustment subunit is configured to adjust the electrical signals, and the second load has a constant load value; and
the sequentially inputting the electrical signals respectively representing the row matrix elements of the target row to the multiplication unit comprised in the row-column calculation unit, obtaining, by the multiplication unit, products of the row matrix elements and column matrix elements in the target column corresponding to the row matrix elements, and inputting, by the multiplication unit, the products to the addition unit comprises:
determining row matrix element timing sequences respectively corresponding to the row matrix elements;
for each of the row matrix element timing sequences, determining a control signal for controlling the electrical signal adjustment subunit based on column matrix elements corresponding to the row matrix element timing sequence; and
inputting the electrical signals to the multiplication unit, wherein in the multiplication unit, the electrical signal adjustment subunit adjusts the electrical signals based on the control signal and applies the adjusted electrical signals to the second load to obtain a second response signal representing the products.

18. The method according to claim 12, wherein
the multiplication unit comprises an electrical signal adjustment subunit and a second load, the electrical signal adjustment subunit is configured to adjust the electrical signals, and the second load has a constant load value; and
the sequentially inputting the electrical signals respectively representing the row matrix elements of the target row to the multiplication unit comprised in the row-column calculation unit, obtaining, by the multiplication unit, products of the row matrix elements and column matrix elements in the target column corresponding to the row matrix elements, and inputting, by the multiplication unit, the products to the addition unit comprises:
determining row matrix element timing sequences respectively corresponding to the row matrix elements;
for each of the row matrix element timing sequences, determining a control signal for controlling the electrical signal adjustment subunit based on column matrix elements corresponding to the row matrix element timing sequence; and
inputting the electrical signals to the multiplication unit, wherein in the multiplication unit, the electrical signal adjustment subunit adjusts the electrical signals based on the control signal and applies the adjusted electrical signals to the second load to obtain a second response signal representing the products.

19. The method according to claim 10, wherein the first matrix is a feature matrix outputted by a neurons of a neural network, and the second matrix is a weight matrix.

20. An integrated circuit, comprising at least one circuit module for performing matrix multiplication according to claim 1.
